(19) United States
(12) Patent Application Publication
(10) Pub. No.: US 2012/0079129 A1
(43) Pub. Date: Mar. 29, 2012

(54) Distribution and Management of Streamable Data

(75) Inventors: David Kallett Rensin, Gainesville, VA (US); Kevin J. Winters, Alexandria, VA (US); Sean C. Osborne, Vienna, VA (US); Richard E. Grenfell, Herndon, VA (US); Brian J. Geoghegan, Vienna, VA (US)

(73) Assignee: REALITY MOBILE LLC, Herndon, VA (US)

(21) Appl. No.: 13/243,680

(22) Filed: Sep. 23, 2011

Related U.S. Application Data
(60) Provisional application No. 61/386,382, filed on Sep. 24, 2010.
(60) Provisional application No. 61/537,182, filed on Sep. 21, 2011.

(51) Int. Cl. G06F 15/16

(52) U.S. Cl. 709/231

(57) ABSTRACT

Methods and systems for distribution and management of streamable data are provided. Streamable data may be pushed out to one or more target client devices from a source device. Streamable data may be pulled from a source device by a client device. A device receiving a command to receive or transmit data may accept, dismiss, ignore, or deny the command. Annotation content may be generated in relation to the streamable data; such annotations may be transmitted concurrently with transmission of the related streamable data. Commands, transmissions, annotations, and metadata may be stored in an archive for later access or review. Data stored in the archive may be processed and converted to a different format in order to further analyze the data, determine statistics, and detect trends.

### RELATED APPLICATIONS

This application claims priority to and the benefit of the filing date of U.S. Provisional Patent Application No. 61/386,382, filed on 24 Sep. 2010, entitled “Streamable-Data Distribution and Management,” and U.S. Provisional Patent Application No. 61/537,182, filed on Sep. 21, 2011, entitled “Scalable Systems and Methods for Managing and Streaming Media,” both of which are hereby incorporated by reference herein in their entireties.

This application also incorporates by reference herein in its entirety U.S. Pat. No. 7,860,994, filed Jan. 16, 2007, entitled “System and Method for Remote Data Acquisition and Distribution,” which claims priority to U.S. Provisional Patent Appln. No. 60/758,983, filed on Jan. 17, 2006.

### INTRODUCTION

This application relates generally to data collection systems and, more particularly to a system and method for distributing and managing streamable data using fixed or mobile computing platforms.

Organizations often need to communicate in real-time with personnel deployed in the field. In particular, rapidly-evolving situations covering multiple personnel in large geographic areas may present challenges with respect to tracking personnel and communications both between deployed personnel and the central communications or management center, and as between different personnel deployed in the field. Ideally, the organization is able to function as a single entity, wherein any member of the organization is able to see and hear what any other member of the organization is experiencing. When this information is coupled with location-based data, the organization can be much more effective at understanding the larger context of multiple incidents, detecting hotspots of activity and responding to emergencies, re-deploying personnel and resources to areas of greater need, and assembling a historical picture of the development of a situation.

Thus, a need exists for a mobile command and control system that can address the issues associated with the real time distribution and management of streamable data using fixed or mobile computing devices.

### BRIEF DESCRIPTION OF THE DRAWINGS

FIG. 1 is a block diagram of the mobile command and control system according to an example disclosed embodiment.

FIG. 2A is a schematic block diagram of an example mobile client device that may be used in the system shown in FIG. 1.

FIG. 2B is a schematic block diagram of an example desktop client device that may be used in the system shown in FIG. 1.

FIG. 3 is a schematic block diagram of example computer hardware for running the management console that may be used in the system shown in FIG. 1.

FIG. 4 is a schematic block diagram of an example streaming media server that may be used in the system shown in FIG. 1.

FIG. 5 is a flow diagram summarizing example processes for managing and distributing streaming data that may be used in the system shown in FIG. 1.

FIG. 6 is a flow diagram summarizing example processes for transmitting streaming data within the system shown in FIG. 1.

FIG. 7 is a flow diagram summarizing example processes for receiving streaming data within the system shown in FIG. 1.

### DESCRIPTION OF EXAMPLE EMBODIMENTS

### Overview

Embodiments of systems and methods consistent with the present disclosure relate to a mobile command and control system that may comprise mobile client software that may be installed on one or more customized and/or commercially available handheld devices or other mobile communication devices. The mobile client software may allow users to collect and transmit live video streams, live audio streams, still images, location data, etc., to a central server via a communication network. The software may allow certain devices designated by a network administrator to remotely access and command one or more client devices, thereby allowing the designated devices to remotely control certain operational aspects associated with the client devices. For example, according to one embodiment, one or more client devices may be designated to, among other things, cause one or more other devices to display a particular video stream or image file. In one embodiment, two or more client devices may create and/or participate in a peer-to-peer network and make data available to other client devices in the peer-to-peer network. Alternatively and/or additionally, one or more client devices may be designated to activate a camera, microphone, location sensing technology, data sensor, or other input device to begin collecting data and streaming the collected data to one or more client devices and/or a central server.

### I. System Architecture

### A. Network

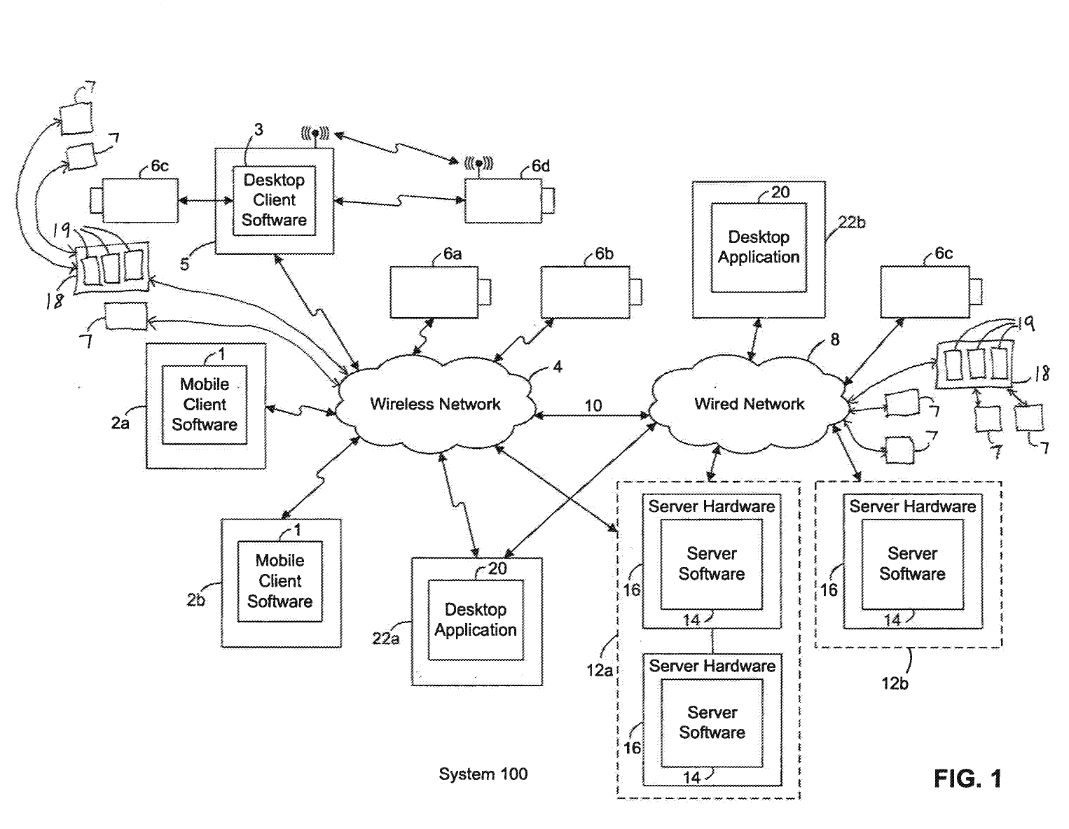

FIG. 1 is a block diagram of an example mobile command and control system (system) 100 consistent with one or more disclosed embodiments. In the embodiment shown, the system 100 may comprise mobile client software 1 that runs on a plurality of mobile communication devices (mobile client devices) 2a, 2b. The mobile client devices 2a, 2b communicate with other components of the system 100 via a wireless network 4. The wireless network can be any type of wireless network, or can be a combination of more than one wireless network. For example, the system 100 can work with any current commercial cellular network (including GSM/GPRS and CDMA/1xRTT) and any faster next-generation data services that might be available such as 3G services (including EDGE, UMTS, HSDPA, EVDO and WCDMA). Other types of wireless networks 4 that can be used in the system 100 according to an example disclosed embodiment may include any wireless local area network (such as a Wi-Fi® network), and any private cellular network, such as a picocell-type base station configuration. A private cellular network can be especially useful in circumstances when the commercial cellular networks are temporarily unavailable, as can occur, for example, in an emergency situation. Still further, the wireless network 4 could be a satellite based wireless system. In some embodiments, mobile client devices 2a and 2b are able to create and/or communicate over a peer-to-peer network of devices, whereby communications are routed through wireless network 4.

In the embodiment shown, the system 100 may further comprise desktop client software 3 that runs on a plurality of desktop personal computers, laptops and other fixed or mobile computer platforms (desktop client devices) 5a, 5b. Desktop client device 5 may communicate with other components of the system 100 via a wireless network 4 or a wired network 8 or a combination of the two. The desktop client software 3 functions in substantially the same manner as the mobile client software 1, allowing for variations in the underlying functionality of the computing platform on which the desktop client software is installed. For ease of reference, and unless the context specifically requires otherwise below, the mobile client software 1 and the desktop client software 3 are referred to collectively as the client software and the mobile client devices 2 and the desktop client devices 5 are referred to collectively as the client devices.

In the embodiment shown, the system 100 may further comprise any or all of an organization's fixed and/or mobile networked cameras 6a, 6b, 6c and 6d and other available fixed or mobile cameras through the networks 4, 8 (e.g., fixed cameras 6) that the organization wishes to incorporate into the system 100. A fixed camera 6 may communicate via the wireless network 4, or can be connected to a wired network 8. The wireless network 4 is connected via a communication path 10 to the wired network 8. The wired network 8 can, and often will, comprise a plurality of wired networks that interface to provide access to/from the client devices. For example, a first wired network 8 can be the Internet, which is then connected to a local area network and/or wide area network, or an organization's other type of wired network. Collectively, these are referred to as the wired network 8. Similarly, wireless network 4 may comprise a plurality of wireless networks, such as interconnected wireless networks of various wireless service providers (e.g., Verizon Wireless, Sprint, Cingular, T-Mobile etc.).

The system 100 may further comprise one or more streaming media servers 12a, 12b. Each streaming media server 12 may be comprised of one or more types of server software 14 that is installed on one or more types of server hardware 16. The streaming media servers 12a, 12b may transmit data to, and receive data from, any client device via wireless network 4 (for example, where the server hardware 16 comprises a laptop or other mobile computing platform that is capable of connecting with wireless network 4 or via wired network 8 or a combination of the two. As described further below, an organization can maintain one or more streaming media servers 12 depending on its specific requirements, each of which may serve a different function in the system 100.

One or more core streaming media servers 12 communicatively coupled with each other and serving as the primary hub for the acquisition and distribution of data files within the system 100.

One or more intervening streaming media servers 12 that act as a data gateway in the system 100 to translate between different data transport mediums. For example, if employee A has an email attachment that he or she wishes to circulate immediately within the system 100, the email may be sent directly to the data gateway address, and the email attachment may be translated into a format suitable for redistribution to one or more client devices through the messaging and routing function described further below.

One or more intervening streaming media servers 12 that act as a proxy server in the system 100 for, among other things, facilitating multiple simultaneous requests by client devices to access one or more fixed cameras 6 that may otherwise be limited in the number of direct simultaneous connections they will support.

As shown, the system 100 may further comprise a desktop application 20 (e.g., a management console) that is installed on one or more personal computers, laptops, or other fixed or mobile computing platforms 22a, 22b. Computing platform 22 communicates with streaming media server 12 and can be connected via wired network 8 or wireless network 4 or a combination of the two. Any person who operates computing platform 22 may be referred to generally as a management console operator. In another embodiment, the functions of computing platform 22 and a streaming media server 12 may be combined in a single computer system. For example, a single computing platform may have installed on it both server software 14 and the desktop application 20. In another embodiment, a variation of the desktop application 20 may be installed separately on a mobile client device 2 or a desktop client device 5. In another embodiment, the management console may be a web app or web service available online.

System 100 may further comprise a number of sensors 7. Sensors 7 may sense any measurable or detectable aspect of an environment, including but not limited to: motion, proximity, radiation, heat/cold, humidity, pressure, smoke, particulate matter, biometrics measured by medical devices, toxic substances, noise, light, vibration, electrical signals, magnetic flux, weight, wind and weather, etc. Sensors 7 may transmit notifications via network 4 and/or 8 when a particular state has been attained and/or exceeded. In some embodiments, notifications from sensors 7 may be received at a gateway 18 that handles such notifications. Notification gateway 18 may comprise software and/or hardware. Particular embodiments of notification gateway 18 are described in further detail below.

### B. Mobile Client Devices

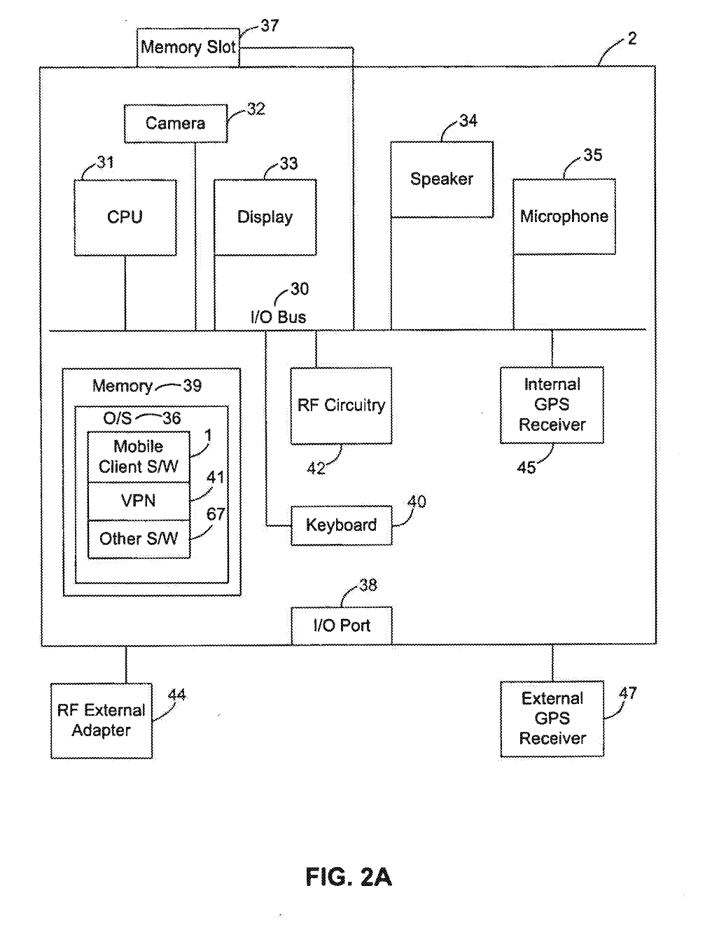

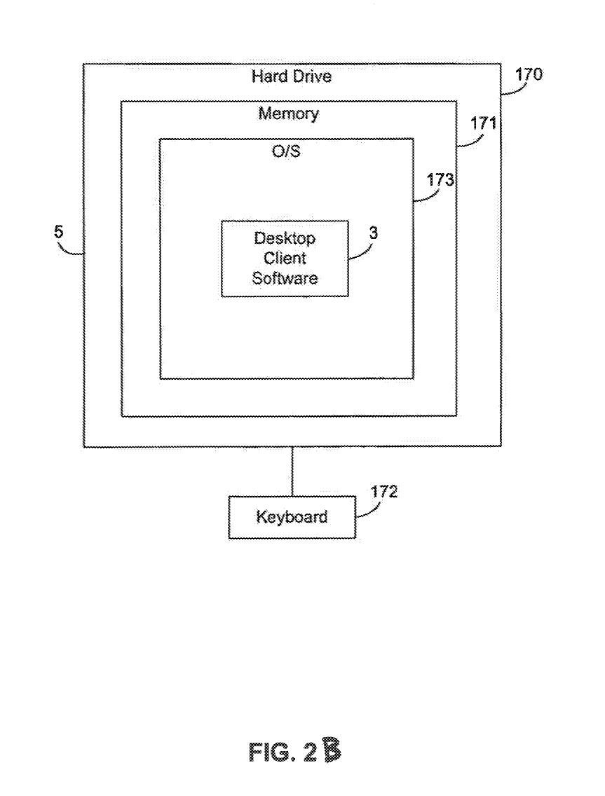

FIG. 2A is a schematic block diagram of an example mobile client device 2 that may be used in the system shown in FIG. 1. The mobile client device 2 can be any mobile device—such as, for example, a Palm™ Treo® smartphone, a Windows®-based Pocket PC or smartphone device, an iOS® device, or an Android® device—that is capable of capturing and transmitting video image data and connecting to a wireless network 4. The mobile client device 2 may comprise an input/output bus 30, a central processing unit (CPU) 31, a camera 32, a display screen 33, a speaker 34, a microphone 35, an operating system 36, a memory slot 37, an input/output port 38, memory 39, and/or a user-input interface (keyboard) 40. Mobile client device 2 may include additional, fewer, and/or different components than those listed above (e.g., an accelerometer, a gyroscope, or a compass).

The mobile client device 2 shown further comprises radio frequency (RF) transmitting/receiving circuitry for wireless communication, such as RF circuitry 42. As one of ordinary skill in the art can appreciate, various types of RF technologies may be used, and mobile client device 2 may include separate RF circuitry 42 to support one or more of them. For example, mobile client device 2 may comprise RF circuitry 42 to support a cellular wireless standard and RF circuitry 42 to support the Bluetooth® short-range wireless connectivity standard, the details of which are known in the art and omitted in the interest of brevity.

In addition, mobile client device 2 may be capable of supporting additional RF technologies through a communicative coupling with other hardware that has RF circuitry embedded in it, such as RF external adapter 44. For example, there are commercially available RF external adapters 44 available to support the Wi-Fi® wireless standard. This type of RF external adapter 44 may attach to the mobile client device 2 in different ways, such as through memory slot 37 or input/output port 38 or through a Bluetooth® wireless connection if both the mobile device 2 and the RF external adapter 44 support that standard.

As shown, mobile client device 2 can have an internal GPS receiver 45 or may be communicatively coupled to an external GPS receiver 47, such as through the memory slot 37, the input/output port 38, or through a Bluetooth® wireless connection if both the mobile device 2 and the external GPS receiver 47 support that standard. In either case, GPS receiver 45 and/or 47 may be used to triangulate longitude, latitude, and other location data by receiving radio wave signals from GPS satellites. Alternatively, a location may be determined by a cellular signal broadcast from the mobile device to triangulate the position of the mobile client device using available cellular emergency location technology (e.g., federal E911 program, etc.). The use of location data is discussed in greater detail below.

As shown on the preceding FIG. 2A, the mobile client device 2 operating system 36 may also contain a virtual private network (VPN) and/or other encryption technology 41 to encrypt the incoming and outgoing data traffic between the mobile client device 2 and an organization's data network. An organization may install on the mobile client device 2 its own preferred encryption technology, such as a commercially available Federal Information Processing Standard (FIPS) 140-2 compliant encryption technology.

In some embodiments, the mobile client device 2 operating system 36 may also be capable of joining and communicating with other devices in a peer-to-peer network. When participating in the peer-to-peer network, mobile client device 2 may be able to make local data available to other devices in the peer-to-peer network, access data located on other devices in the peer-to-peer network, push data to other devices in the peer-to-peer network, and coordinate operations with other devices in the peer-to-peer network as necessary (e.g., distributed computing, distributed storage of data).

It is contemplated that operating system 36 associated with mobile client device 2 may contain additional and/or different programs than those listed above, such as one or more software applications 67. It is further contemplated that components and/or software described in association with operating system 36 are for example only, and not intended to be limiting.

Some aspects of the example notification gateway and associated software may be described in further detail in U.S. Provisional Patent Application No. 61/386,382, filed on Sep. 24, 2010, U.S. Provisional Patent Application No. 61/537,182, filed on Sep. 21, 2011, and/or in U.S. Pat. No. 7,860,994, filed Jan. 16, 2007, all of which are incorporated by reference herein in their entireties.

### C. Desktop Client Devices

FIG. 2B is a schematic block diagram of an example disclosed desktop client device 5 that is running the desktop client application 20 consistent with one example embodiment. Desktop client device 5 may include any desktop personal computer, laptop or other fixed or mobile computer platform that is capable of running an operating system 173, such as, for example, the Windows 2000® operating system or a later version. Each desktop client device 5 may also include, among other components, a hard drive 170, memory 171 and a keyboard 172. Desktop client software 3 may run on the operating system 173. Desktop client device 5 may include additional, fewer, and/or different components than those listed above.

As noted earlier, the desktop client software 3 may function in substantially the same manner as the mobile client software 1. For example, as with a mobile client device 2, a desktop client device 5 can have an internal GPS receiver 45 or may be communicatively coupled to an external GPS receiver 47, such as through a USB serial connection or through a Bluetooth® wireless connection. Further, the desktop client device 5 may also comprise any number of components depending on the nature of the data being transmitted within the system 100.

As with a mobile client device 2, it is contemplated that operating system 173 associated with a desktop client device 5 may contain additional and/or different programs than those listed above, such as one or more software applications. It is further contemplated that components and/or software described in association with operating system 173 are for example only, and not intended to be limiting.

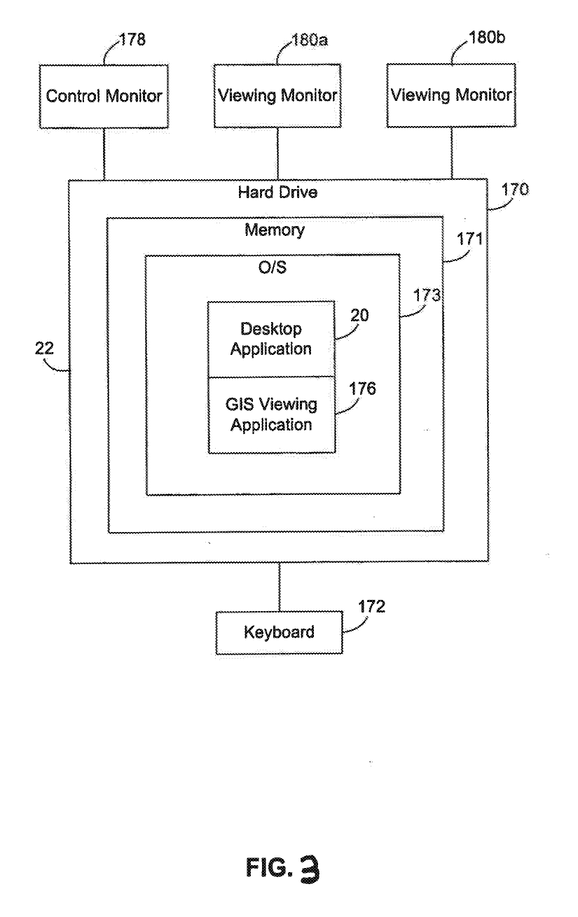

As shown in FIG. 3, the computing platform 22 may further comprise one or more computer monitors or any other video display system integrated into the system 100. In the case of one or more computer monitors, for example, an example control monitor 178 may display the desktop application described further below while one or more additional computer monitors—viewing monitors 180a, 180b—may display data collected through the system 100 in various formats, such as viewing image streams from the fixed cameras 6 or from any client device using one or more integrated GIS viewing applications 176. In another embodiment, an organization may use a single display monitor, as in the case of a laptop, in which case the management console operator may simply toggle between screens or display them simultaneously in separate windows, etc.

The computing platform 22 may also include any hardware and software components typically found in a computer, the details of which are omitted in the interest of brevity.

Some aspects of the example notification gateway and associated software may be described in further detail in U.S. Provisional Patent Application No. 61/386,382, filed on Sep. 24, 2010, U.S. Provisional Patent Application No. 61/537,182, filed on Sep. 21, 2011, and/or in U.S. Pat. No. 7,860,994, filed Jan. 16, 2007, all of which are incorporated by reference herein in their entireties.

### D. Streaming Media Server

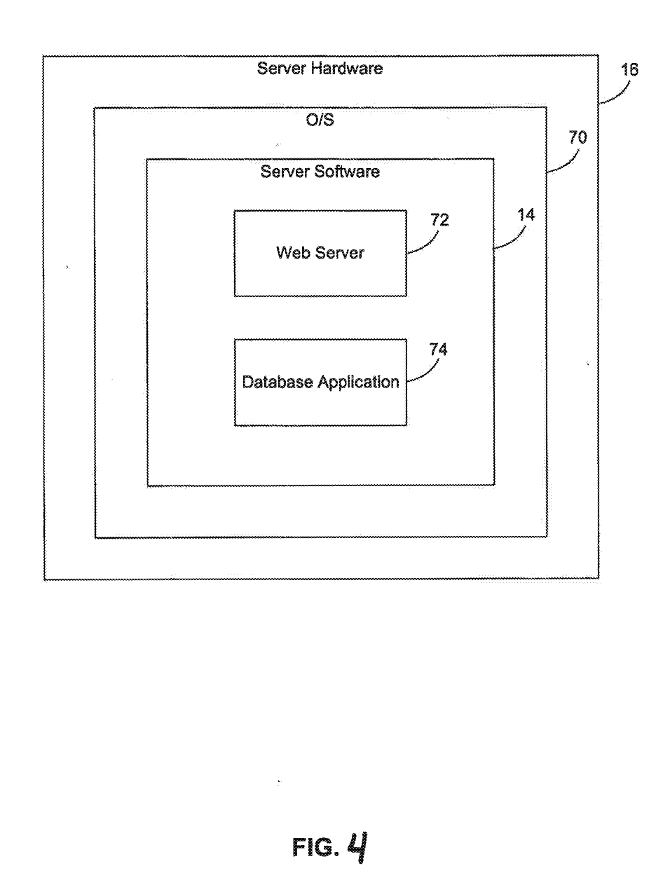

FIG. 4 is a schematic block diagram illustrating components that may be associated with streaming media server 12, according to an example embodiment. Among other components, streaming media server 12 may include server hardware 16 on which runs a server operating system 70 and the server software 14. In one embodiment, the server hardware 16 can be any server hardware that supports an operating system, such as a Microsoft® operating system. According to one embodiment the server operating system 70 may include the Windows XP® operating system or other suitable operating system. The server software 14 may also include a Web server 72 and a database application 74, each of which is described further below. Streaming media server 12 may include additional, fewer, and/or different components than those listed above.

In one embodiment, the Web server 72 may include the Microsoft® Internet Information Services Web Server® and the database application 74 may include the Microsoft® SQL Server. However, it is contemplated that additional and/or different applications may be included with server operating system 70, Web server 72 and/or database application 74, respectively. It is further contemplated that components and/or software described in association with operating system 70 are for example only, and not intended to be limiting.

Some embodiments of a scalable streaming media server pool support multiple types of industry standards and protocols for streaming video, audio, and other content types. Some embodiments of a scalable streaming media server pool can be deployed in cluster configurations, failover configurations, and load balancing configurations. Some embodiments of a scalable streaming media server pool include multiple data repositories where content is archived. Some embodiments of a scalable streaming media server pool include a metadata repository where each live transmission may be registered and its location recorded (to indicate at least on which server it is hosted).

Some aspects of the example streaming media server, the streaming media server pool, and associated software may be described in further detail in U.S. Provisional Patent Application No. 61/386,382, filed on Sep. 24, 2010, U.S. Provisional Patent Application No. 61/537,182, filed on Sep. 21, 2011, and/or in U.S. Pat. No. 7,860,994, filed Jan. 16, 2007, all of which are incorporated by reference herein in their entireties.

### E. Notification Gateway

As shown in FIG. 1, example notification gateway 18 receives real-time event data and generates commands. In some embodiments, real-time event data may be generated automatically by a sensor, another client device, or some other system component. Notification gateway 18 may support multiple protocols (e.g., SMTP, FTP, HTTP, TCP) through extensions. In some embodiments of notification gateway 18, a notification is received from sensor 7 when an event occurs. In some embodiments, the notification is automatically generated when a sensor detects that certain thresholds of measurement have been attained or exceeded. Notification gateway 18 may be pre-configured to map particular sensor notifications to one or more commands with one or more recipients. For example, when sensor 7 sends a notification to notification gateway 18 that the air pollution has exceeded a prescribed level of parts-per-million, notification gateway 18 (1) receives the notification, (2) determines that some action needs to be taken, such as sending out a command to one or more users, (3) looks up the set of recipients in a data store, and (4) transmits a command to the devices of the one or more recipients.

In some embodiments, sensor 7 transmits the notification using any one of a number of standard protocols, such as SMTP (Simple Mail Transfer Protocol), FTP (File Transfer Protocol), HTTP (Hyper-Text Transfer Protocol), or TCP (Transmission Control Protocol). In order to handle different protocols, notification gateway 18 may include a plug-in 19 for each protocol. For example, when sensor 7 transmits a SMTP notification that the air pollution has exceeded a prescribed level of parts-per-million, notification gateway 18 handles the notification using a SMTP plug-in to extract the information regarding the notification.

In some embodiments, when notification gateway 18 determines that some action needs to be taken, the action is automatically inferred by the plug-in 19 that handled the incoming notification. In some embodiments, notification gateway 18 may be configured to handle user-defined actions—in these embodiments, notification gateway 18 may look up the appropriate user-defined action to be taken in a data store.

In some embodiments, a user interface is provided to configure the gateway. The user interface may enable an administrator or other user to configure event handling, set up recipients for different scenarios, and configure user-defined actions. In some embodiments, a plug-in may add to the list of events that can occur.

In some embodiments, sensor 7 may be replaced with other types of systems whose state can be monitored from the notification gateway 18. In some embodiments, a plug-in may be added to the notification gateway 18 to monitor the state of the other systems. In some embodiments, the notification gateway 18 automatically distributes streamable data to a pre-defined list of users, groups, and/or devices when a notification is triggered. In some embodiments, the definition of the pre-defined list of users, groups, and/or devices includes a dynamic determination based upon any number of factors (e.g., proximity of a user to a given location).

Some aspects of the example notification gateway and associated software may be described in further detail in U.S. Provisional Patent Application No. 61/386,382, filed on Sep. 24, 2010, U.S. Provisional Patent Application No. 61/537,182, filed on Sep. 21, 2011, and/or in U.S. Pat. No. 7,860,994, filed Jan. 16, 2007, all of which are incorporated by reference herein in their entireties.

### II. Processes for the Streaming Media Management and Distribution Server

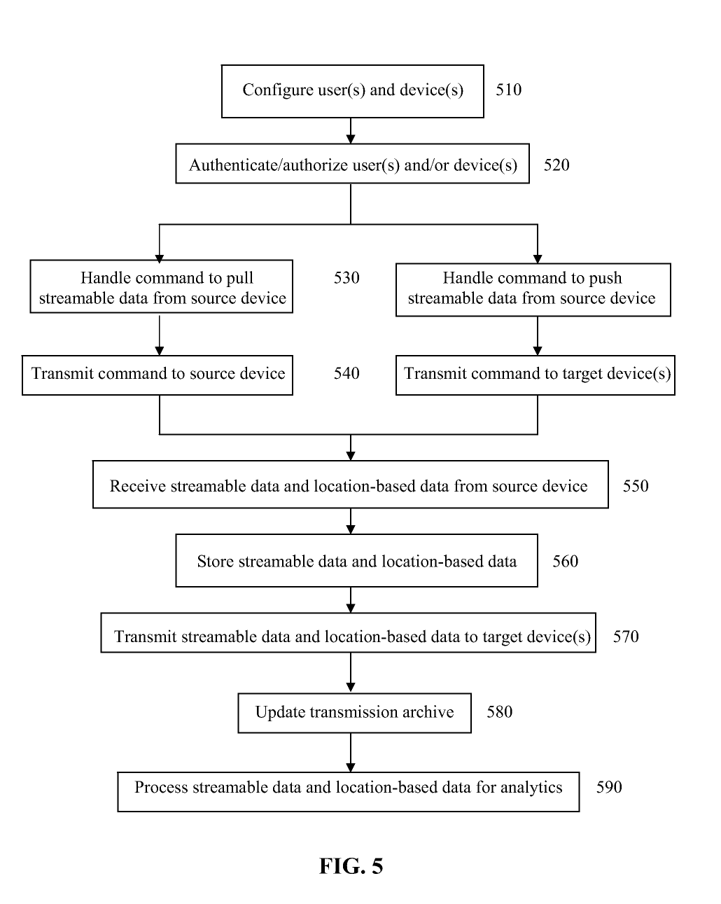

FIG. 5 illustrates an example method for managing and distributing streaming data that may be used in the system shown in FIG. 1.

Some embodiments of the server may enable configuration of users and devices, as in step 510. Some embodiments may also provide a user interface for such configuration. Users may be associated with one or more devices. Users also may be organized into groups. Groups may be organized into multi-level hierarchies. Security settings may be based upon any relevant attribute related to any factor, including but not limited to user(s), group(s), device(s), content type(s), location(s), date/time, etc.

Some embodiments of the server may enable authentication and/or authorization of a user and/or a device, as in step 520. Authentication and/or authorization of a user and/or a device may be handled in any conventional manner.

Some embodiments of the server may enable handling commands transmitted from a client device, as in steps 530. Some embodiments of the server may handle commands to pull streamable data from a source device, which may include a sensor, a fixed or mobile camera or microphone, or a desktop or mobile client device. Some embodiments of the server may handle commands to push streamable data from a source device to one or more target devices, such as a desktop or mobile client device. Some embodiments of the server may handle automated event-driven commands to pull streamable data from a source device and/or push streamable data to one or more target devices. Some embodiments of the server may handle automated commands to poll or ping one or more source devices or one or more target devices.

Some embodiments of the server may enable transmission of the command to the intended recipient, as in step 540. Embodiments of the server that handle commands to pull streamable data from a source device may transmit the command to the source device. Embodiments of the server that handle commands to push streamable data from a source device to one or more target devices may transmit the command to the source device and/or the one or more target devices. In some embodiments of the server, the recipient of the command may accept, dismiss, ignore, or deny the command. In some embodiments of the server, when the recipient of the command dismisses or ignores a command to receive or consume data, the recipient may access the data at his or her convenience in an archive. In some embodiments of the server, the originator of the command may additionally request a read receipt; in some embodiments, the recipient may choose to send or withhold the read receipt.

Some embodiments of the server may enable receiving streamable data, location-based data, and other associated data or metadata, as in step 550. In some embodiments of the server, such other associated data may included appended annotation data Annotation data may be of any content type, including but not limited to text, audio, video, images, source code, etc.

Some embodiments of the server may enable storing the streamable data, location-based data, and other associated data or metadata, as in step 560. Some embodiments may include multiple levels and/or types of storage and/or archives, including but not limited to databases, caches, compressed archives, etc.

Some embodiments of the server may enable transmitting the streamable data, location-based data, and/or other associated data or metadata, or portions thereof, as in step 570. Some embodiments of the server may enable manipulation of transmitted data, such as by causing playback of streaming video or audio to commence at a selected time or date prior to the current time or date. Some embodiments of the server may enable manipulation of the source device, such as panning, tilting, or zooming to enhance an image or video. In some embodiments of the server, such other associated data may included appended annotation data.

Some embodiments of the server may enable updating an archive, whereby commands, transmissions, annotations, metadata, and consumption of transmissions are recorded and/or logged, as in step 580. In some embodiments of the server, records of commands, transmissions, annotations, metadata, and consumption of transmissions in such a transmission archive may be viewed by either any user or only by the originator and/or recipient of the command or transmission. In some embodiments, such commands, transmissions, annotations, metadata, and consumption of transmissions may be recorded and/or logged on a per-user basis; in some embodiments, such commands, transmissions, annotations, metadata, and consumption of transmissions may be recorded and/or logged on a per-device basis.

Some embodiments of the server may enable processing of streamable data, location-based data, and other associated data or metadata for analytics purposes, as in step 590.

Some aspects of example servers and associated processes may be described in further detail in U.S. Provisional Patent Application No. 61/386,382, filed on Sep. 24, 2010, U.S. Provisional Patent Application No. 61/537,182, filed on Sep. 21, 2011, and/or in U.S. Pat. No. 7,860,994, filed Jan. 16, 2007, all of which are incorporated by reference herein in their entireties.

### III. Processes for Streaming Media Clients

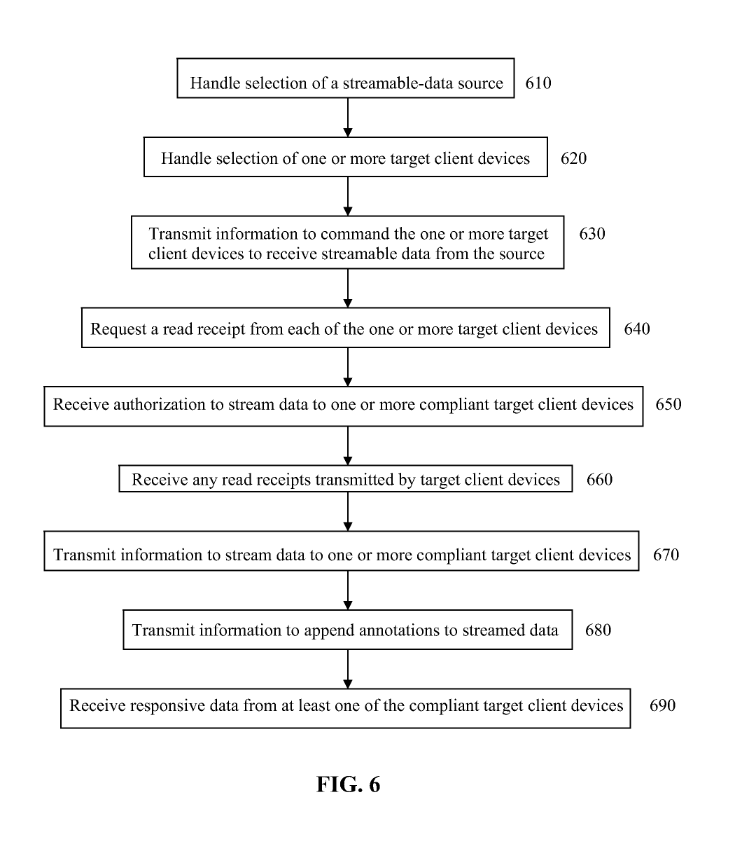

FIG. 6 is a flow diagram summarizing example client processes for transmitting streaming data by client devices within the system shown in FIG. 1.

Some embodiments of the client processes may enable handling a selection of a streamable-data source, as in step 610. In some embodiments, a streamable-data source may include a sensor, a fixed or mobile camera or microphone, and/or a desktop or mobile client device.

Some embodiments of the client processes may enable handling a selection of one or more target client devices and/or users and/or groups, as in step 620.

Some embodiments of the client processes may enable transmitting information to command the one or more target client devices to receive streamable data, location-based data, and/or other associated data or metadata from the source, as in step 630.

Some embodiments of the client processes may enable requesting a read receipt from each of the one or more target client devices, as in step 640.

Some embodiments of the client processes may enable receiving responses authorizing data streaming to one or more target client devices that comply with the command, as in step 650.

Some embodiments of the client processes may enable receiving any read receipts transmitted by target client devices, as in step 660.

Some embodiments of the client processes may enable transmitting information to stream data to the one or more compliant target client devices, as in step 670.

Some embodiments of the client processes may enable transmitting information to append annotations to streamed data, as in step 680.

Some embodiments of the client processes may enable receiving streamed data, annotations, metadata, or other data from a compliant target device in response to the data that was streamed to that compliant target device, as in step 690.

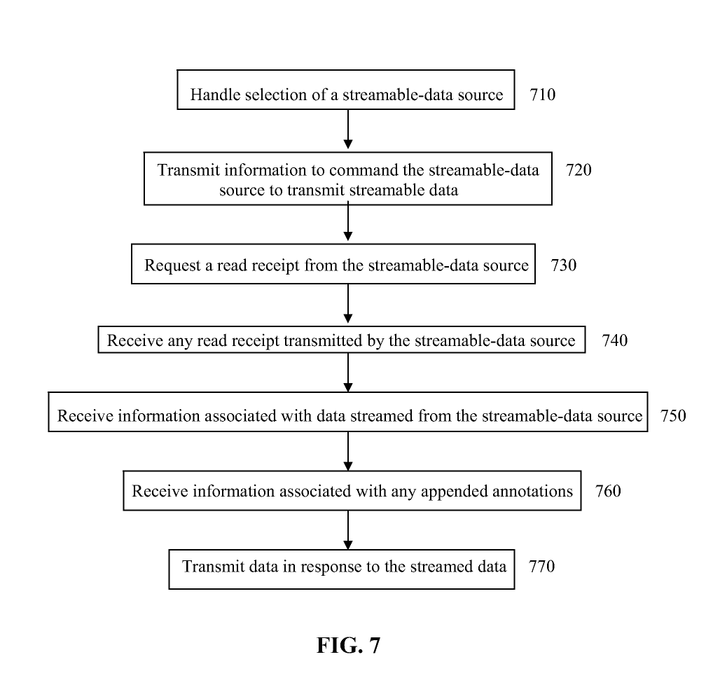

FIG. 7 is a flow diagram summarizing example client processes for receiving streaming data by client devices within the system shown in FIG. 1.

Some embodiments of the client processes may enable handling a selection of a streamable-data source, as in step 710. In some embodiments, a streamable-data source may include a sensor, a fixed or mobile camera or microphone, and/or a desktop or mobile client device.

Some embodiments of the client processes may enable transmitting information to command the streamable-data source to transmit streamable data, location-based data, and/or other associated data or metadata from the source, as in step 720.

Some embodiments of the client processes may enable requesting a read receipt from the streamable-data source, as in step 730.

Some embodiments of the client processes may enable receiving any read receipt transmitted by the streamable-data source, as in step 740.

Some embodiments of the client processes may enable receiving information associated with data streamed from the streamable-data source to, as in step 750.

Some embodiments of the client processes may enable receiving information associated with any annotations appended to the streamed data, as in step 760.

Some embodiments of the client processes may allow the recipient of the streamed data to transmit streaming data or other data to the streamable-data source in response to the streamed data, as in step 770.

Some embodiments of the client processes may enable automatic and/or manual updates to software installed on client devices.

Some aspects of example clients and associated processes may be described in further detail in U.S. Provisional Patent Application No. 61/386,382, filed on Sep. 24, 2010, U.S. Provisional Patent Application No. 61/537,182, filed on Sep. 21, 2011, and/or in U.S. Pat. No. 7,860,994, filed Jan. 16, 2007, all of which are incorporated by reference herein in their entireties.

### IV. Management Console

Some embodiments of a management console enable management and configuration of users and groups, including data access permissions. Some embodiments of a management console enable management and configuration of devices associated with one or more users.

Some embodiments of a management console enable issuing commands to source devices and target client devices. Some embodiments of a management console enable adding context to commands, wherein context may be added by using different content types. Some embodiments of a management console enable creating new commands, editing existing commands, and removing commands.

Some embodiments of a management console enable GPS plotting and tracking in mapping applications. Some embodiments of a management console enable management of tracking lists.

Some embodiments of a management console enable transmission of non-streaming data, such as still images, messages, links to online content, electronic files, etc.

Some embodiments of a management console enable viewing a history of commands and transmissions.

It is contemplated that various component and/or subsystems associated with the disclosed data acquisition and distribution system may be included as part of a separate system or may be integrated within one or more other systems. For example, it is contemplated that the processes and/or systems associated with the management console may be implemented on computing platform 22 or one or more mobile client devices, designated to operate as the management console. Alternatively and/or additionally, although FIG. 2A illustrates certain components as components external to mobile client device 2 (e.g., RF external adapter and external GPS receiver), it is contemplated that these components may be integrated within mobile client device 2, without departing from the scope of the present disclosure and the embodiments associated therewith.

Similarly, it is contemplated that various processes illustrated and/or described as being associated with certain components and/or systems may be associated with other components and/or systems. For instance, it is contemplated that certain processes performed by the management console may be performed by computing platform 22 or one or more client devices. Accordingly, it is contemplated that any feature, process, and/or system associated with the management console may be associated with a client device. Thus, one or more client devices may be designated as a management console for performing the command and control processes associated with the disclosed embodiments.

Some aspects of an example management console and associated processes may be described in further detail in U.S. Provisional Patent Application No. 61/386,382, filed on Sep. 24, 2010, U.S. Provisional Patent Application No. 61/537,182, filed on Sep. 21, 2011, and/or in U.S. Pat. No. 7,860,994, filed Jan. 16, 2007, all of which are incorporated by reference herein in their entireties.

Furthermore, although certain components or systems may be described as being “mobile,” it is contemplated that this term may also refer to fixed devices that may be configured as “mobile” or “virtually mobile” devices. For example, throughout the disclosure, reference is made to mobile client devices. It is contemplated that this term may refer to desktop and/or network clients configured, with certain software such as mobile client software, to possess many of the same functionalities as the mobile client device.

The present invention has been described with reference to certain example embodiments thereof. However, it will be readily apparent to those skilled in the art that it is possible to embody the invention in specific forms other than that those of the example embodiments described above. This may be done without departing from the spirit and scope of the invention. The example embodiments described herein are merely illustrative and should not be considered restrictive in any way.

1.-7. (canceled)

8. A method comprising, by one or more computer systems:
receiving user input selecting approximately real-time streamable data from a streamable-data source;
receiving information associated with one or more annotations, wherein each annotation is related to one or more portions of the approximately real-time streamable data;
receiving user input selecting one or more target client devices; and
transmitting information to present the approximately real-time streamable data along with the one or more annotations on the selected target client devices.

9. The method of claim 8, wherein the approximately real-time streamable data is transmitted to the one or more target client devices from an archive.

10. The method of claim 8, wherein the approximately real-time streamable data is transmitted to the one or more target client devices from the streamable-data source.

11. The method of claim 8, wherein the information associated with one or more annotations comprises a selection of one or more of a plurality of shortcuts, wherein each shortcut corresponds to a predetermined annotation conveying particular information with respect to the approximately real-time streamable data.

12. A method comprising:
transmitting, by a client device, information to present streamable data at one or more target client devices along with location information associated with a source of the streamable data; and
receiving, at the client device, information to display responsive data transmitted from at least one of the one or more target client devices.

13. The method of claim 12, wherein the source of the streamable data is at the client device.

14. The method of claim 12, wherein the source of the streamable data comprises a viewing window that overlies one or more portions of one or more display elements within the display of the client device, the portions of the display elements being viewable to a user accessing the client device through the viewing window.

15. The method of claim 12, wherein the source of the streamable data is remote from the client device.

16. The method of claim 12, further comprising communicating an alert to at least one of the one or more target client devices.

17. A method comprising, by one or more computer systems:
receiving a selection of one or more streamable-data sources;
receiving a selection of one or more target client devices to receive approximately real-time streamable data from the one or more streamable-data sources;
transmitting information to display the approximately real-time streamable data from the one or more streamable-data sources on the one or more target client devices; and
receiving responsive data transmitted from the one or more target client devices, wherein the responsive data is transmitted concurrently with the transmission of the approximately real-time streamable data to the one or more target client devices.

18. The method of claim 8, wherein the information associated with one or more annotations comprises at least one of streamable data, images, text, audio, or metadata.

19. The method of claim 8, further comprising:
receiving user input toggling off display of annotations; and
transmitting information to present the approximately real-time streamable data without the one or more annotations.

20. The method of claim 8, wherein the information associated with one or more annotations comprises text.

21. The method of claim 17, wherein the approximately real-time streamable data is presented in conjunction with the responsive data.

22. The method of claim 17, further comprising transmitting, to the one or more target client devices, a command to send responsive data in relation to the approximately real-time streamable data.

23. The method of claim 17, further comprising pausing transmission of the approximately real-time streamable data in order to receive the responsive data.
